(19) United States
(12) Patent Application Publication
(10) Pub. No.: US 2025/0200912 A1
(43) Pub. Date: Jun. 19, 2025

(54) AUGMENTED REALITY SYSTEM

(71) Applicant: Snap Inc., Santa Monica, CA (US)

(72) Inventors: Piers George Cowburn, London (GB); Qi Pan, London (GB); Isac Andreas Müller Sandvik, London (GB)

(21) Appl. No.: 19/065,929

(22) Filed: Feb. 27, 2025

Related U.S. Application Data
(63) Continuation of application No. 18/133,469, filed on Apr. 11, 2023, now Pat. No. 12,266,062.
Application No. 18/133,469 is a continuation of application No. 17/729,678, filed on Apr. 26, 2022, now Pat. No. 11,721,080.
Application No. 17/729,678 is a continuation of application No. 16/921,487, filed on Jul. 6, 2020, now Pat. No. 11,335,067.
Application No. 16/921,487 is a continuation of application No. 15/706,074, filed on Sep. 15, 2017, now Pat. No. 10,740,974.

(51) Int. Cl. G06T 19/00; G06F 3/0482; G06F 3/04842; G06T 1/00; G06T 15/20; G06T 19/20; H04L 67/01; H04L 67/02; H04L 67/131; H04L 67/306; H04L 67/52

(52) U.S. Cl. CPC G06T 19/006; G06T 15/20; G06T 19/20; H04L 67/131; H04L 67/52; G06F 3/0482; G06F 3/04842; G06T 1/0021; G06T 2200/24; G06T 2219/024; H04L 67/01; H04L 67/02; H04L 67/306

(57) ABSTRACT

An augmented reality system to generate and cause display of a presentation of a space at a first client device, receive one or more selections of points within the presentation of the space at the first client device, and render graphical elements at the one or more points within the presentation of the space at the first client device. The augmented reality system is further configured to receive a display request to display the space at a second client device, and in response, may render a second presentation of the space at the second client device, wherein the second presentation of the space includes the graphical elements at the one or more points.

### CLAIM OF PRIORITY

This application is a continuation of U.S. patent application Ser. No. 18/133,469, filed Apr. 11, 2023, which application is a continuation of U.S. patent application Ser. No. 17/729,678, filed Apr. 26, 2022, now issued as U.S. Pat. No. 11,721,080, which application is a continuation of U.S. patent application Ser. No. 16/921,487, filed Jul. 6, 2020, now issued as U.S. Pat. No. 11,335,067, which application is a continuation of U.S. patent application Ser. No. 15/706,074, filed on Sep. 15, 2017, now issued as U.S. Pat. No. 10,740,974, which are incorporated herein by reference in their entirety.

### TECHNICAL FIELD

Embodiments of the present disclosure relate generally to mobile computing technology and, more particularly, but not by way of limitation, to systems for generating and presenting augmented reality media content.

### BACKGROUND

Augmented reality (AR), is a live direct or indirect view of a physical, real-world environment whose elements are augmented by computer-generated sensory inputs.

### BRIEF DESCRIPTION OF THE SEVERAL VIEWS OF THE DRAWINGS

To easily identify the discussion of any particular element or act, the most significant digit or digits in a reference number refer to the figure number in which that element is first introduced.

FIG. 1 is a block diagram showing an example messaging system for exchanging data (e.g., messages and associated content) over a network in accordance with some embodiments, wherein the messaging system includes an engagement tracking system.

FIG. 2 is block diagram illustrating further details regarding a messaging system, according to example embodiments.

FIG. 3 is a schematic diagram illustrating data which may be stored in the database of the messaging server system, according to certain example embodiments.

FIG. 4 is a schematic diagram illustrating a structure of a message, according to some embodiments, generated by a messaging client application for communication.

FIG. 5 is a schematic diagram illustrating an example access-limiting process, in terms of which access to content (e.g., an ephemeral message, and associated multimedia payload of data) or a content collection (e.g., an ephemeral message story) may be time-limited (e.g., made ephemeral) in accordance with some embodiments.

FIG. 6 is a block diagram illustrating various modules of an augmented reality system, according to certain example embodiments.

FIGS. 7A/B include depictions of exemplary graphical user interfaces to display augmented reality presentations of media content, according to certain example embodiments.

FIG. 8 is a flowchart illustrating a method for causing display of an augmented reality presentation of a space, according to certain example embodiments.

FIG. 9 is a flowchart illustrating a method for causing display of an augmented reality presentation of a space, according to certain example embodiments.

FIG. 10 is a flowchart illustrating a method for causing display of an augmented reality presentation of a space, according to certain example embodiments.

FIG. 11 is a block diagram illustrating a representative software architecture, which may be used in conjunction with various hardware architectures herein described and used to implement various embodiments.

FIG. 12 is a block diagram illustrating components of a machine, according to some example embodiments, able to read instructions from a machine-readable medium (e.g., a machine-readable storage medium) and perform any one or more of the methodologies discussed herein.

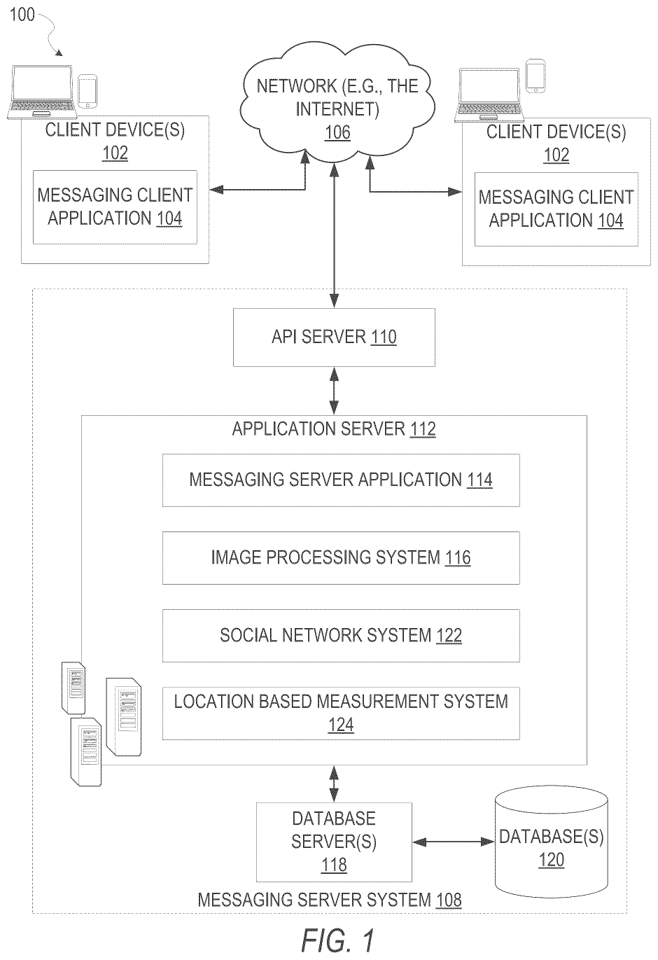

### DETAILED DESCRIPTION

Embodiments of the present disclosure relate generally to mobile computing technology and, more particularly, but not by way of limitation, to systems for generating and presenting augmented reality media content. An Augmented Reality (AR) system as described herein may be or include any instrumentality or aggregate of instrumentalities operable to compute, process, store, display, generate, communicate, or apply various forms of data for generating and presenting interfaces for the display of AR media content.

In accordance with various embodiments described herein, an AR system generates and causes display of a presentation of a space at a first client device, receives one or more selections of points within the presentation of the space at the first client device, and renders graphical elements at the one or more points within the presentation of the space at the first client device. The AR system is further configured to receive a display request to display the space at a second client device, and in response, may render a second presentation of the space at the second client device, wherein the second presentation of the space includes the graphical elements at the one or more points.

In some example embodiments, the AR system retrieves location data that identifies a location of the first client device in response to receiving the selections of the one or more points within the presentation of the space. Based on the location data, the AR system determines a perspective of the first client device relative to the one or more points. The perspective of the first client device indicates a “point of view” of the device when viewing the one or more points. The AR system determines an orientation of each of the graphical elements based on the perspective of the first client device relative to the one or more points. The AR system renders the graphical elements based on the determined orientations, at the one or more points within the presentation of the space.

Similarly, in some embodiments the AR system retrieves location data corresponding to the second client device in response to receiving a request to display a presentation of the space that includes the one or more points selected at the first client device. The AR system determines a perspective of the second client device based on the location data of the second client device relative to the one or more points, and determines orientations of the graphical elements based on the perspective of the second client device. The AR system renders the graphical elements within the presentation of the space at the second client device based on the determined orientations, at the one or more points within the space. In this way, the graphical elements may be rendered and re-rendered based on a location of a client device.

In some example embodiments, the graphical element may be displayed within the presentation of the space with an indication of a location of a client device. For example, in response to receiving a selection of a point within a presentation of a space from a first client device, the AR system may retrieve location data that identifies the location of the first client device, and renders the graphical element at the point within the presentation of the space, along with an indication of the location of the first client device. The indication of the location of the first client device may include an arrow, or similar visual indicator. In some embodiments, the graphical element may appear as a projection emanating from a source at the location of the first client device, with a visible projection beam extending from the location of the first client device and terminating at the point with the graphical element.

In some example embodiments, the indication of the location of the client device may be personalized based on user inputs. For example, a user of the first client device may additionally provide a selection of properties of the indication of the location. The properties may for example include size, color, style, animation, etc. In response, the AR system renders the graphical element at the selected point with the indication of the location based on the properties selected by the user.

Consider an illustrative example from a user perspective, demonstrating embodiments wherein two users at two distinct client devices may communicate with one another through the use of media content displayed in an AR interface. A first user of a first client device may display a presentation of a space at the first client device—for example, the space may be a view point of a landscape. The first user may be at a southern most point in a city, viewing a skyline of the city from a first perspective. The first user may provide an input into the presentation of the space, to select a specific point above the skyline. In response to receiving the selection of the point within the presentation of the space, the AR system retrieves location data corresponding to the first client device, and causes display of a set of graphical elements at the first client device. The set of graphical elements may include graphical representations of objects with animation such as balloons, fireworks, hot air balloons, blimps etc., or may also include an option to enable to the user to select a graphical element from an external source. In some embodiments, the AR system may also provide an interface to receive a text string, wherein the graphical element selected by the user may be modified to include the text string.

The first user may thereby provide an input selecting a graphical element from among the set of graphical elements, or may provide an input drawing a graphical element directly onto the presentation of the space. In some embodiments, the user may both select a graphical element and draw a graphical element, wherein both graphical elements may be displayed together. For example, a user may select a graphical element and provide further inputs drawing or making changes to the graphical element, such as changing a color of the graphical element, adding lines or details to the graphical element, or editing text associated with the graphical element. For purposes of this illustrative example, the first user may provide an input selecting a graphical icon representative of a blimp. In response to receiving the selection of the graphical element, the AR system determines a perspective of the first client device based on the location data and the point selected by the first user. Based on the perspective, the AR system determines an orientation to display the graphical element of the blimp within the presentation of the space. In some embodiments, the first user may additionally provide directional inputs to set the full position and orientation of the graphical element within the presentation of the space. For example, the user may provide inputs to rotate, and translate the graphical element within the presentation of the space.

The AR system causes display of the graphical element within the presentation of the space at the first client device. From the perspective of the first user, the presentation of the space (which includes a skyline of the city) includes a blimp at the location selected by the user. As the user traverses and changes location, the AR system may make adjustments to the orientation of the blimp in real-time, giving the illusion that the blimp is floating above the skyline, at the location which the user selected.

The AR system next receives a request to display a presentation of the space (e.g., the skyline) from a second client device. In response to receiving the request to display the presentation of the space, the AR system retrieves location data corresponding to the second client device. Based on the location data of the second client device, the AR system determines an appropriate orientation of the blimp (the graphical element) at the point within the presentation of the space at the second client device. The AR system then generates and displays the presentation of the space at the second client device, with the blimp at the appropriate orientation.

The user of the second client device may provide inputs into the presentation of the space, to interact with the graphical element. In response to receiving the inputs interacting with the graphical element from the second client device, the AR system alters the graphical element in the presentation at both the first client device and the second client device. For example, the second user may provide an input to “pop” the blimp. In response to receiving the input, the AR system alters the presentation to depict a change in the graphical element—for example, the blimp may deflate or fall from the point in the skyline.

Accordingly, each messaging client application 104 is able to communicate and exchange data with another messaging client application 104 and with the messaging server system 108 via the network 106. The data exchanged between messaging client applications 104, and between a messaging client application 104 and the messaging server system 108, includes functions (e.g., commands to invoke functions) as well as payload data (e.g., text, audio, video or other multimedia data).

The messaging server system 108 provides server-side functionality via the network 106 to a particular messaging client application 104. While certain functions of the messaging system 100 are described herein as being performed by either a messaging client application 104 or by the messaging server system 108, it will be appreciated that the location of certain functionality either within the messaging client application 104 or the messaging server system 108 is a design choice. For example, it may be technically preferable to initially deploy certain technology and functionality within the messaging server system 108, but to later migrate this technology and functionality to the messaging client application 104 where a client device 102 has a sufficient processing capacity.

The messaging server system 108 supports various services and operations that are provided to the messaging client application 104. Such operations include transmitting data to, receiving data from, and processing data generated by the messaging client application 104. In some embodiments, this data includes, message content, client device information, geolocation information, media annotation and overlays, message content persistence conditions, social network information, and live event information, as examples. In other embodiments, other data is used. Data exchanges within the messaging system 100 are invoked and controlled through functions available via user interfaces (UIs) of the messaging client application 104.

Turning now specifically to the messaging server system 108, an Application Program Interface (API) server 110 is coupled to, and provides a programmatic interface to, an application server 112. The application server 112 is communicatively coupled to a database server 118, which facilitates access to a database 120 in which is stored data associated with messages processed by the application server 112.

Dealing specifically with the Application Program Interface (API) server 110, this server receives and transmits message data (e.g., commands and message payloads) between the client device 102 and the application server 112. Specifically, the Application Program Interface (API) server 110 provides a set of interfaces (e.g., routines and protocols) that can be called or queried by the messaging client application 104 in order to invoke functionality of the application server 112. The Application Program Interface (API) server 110 exposes various functions supported by the application server 112, including account registration, login functionality, the sending of messages, via the application server 112, from a particular messaging client application 104 to another messaging client application 104, the sending of media files (e.g., images or video) from a messaging client application 104 to the messaging server application 114, and for possible access by another messaging client application 104, the setting of a collection of media data (e.g., story), the retrieval of a list of friends of a user of a client device 102, the retrieval of such collections, the retrieval of messages and content, the adding and deletion of friends to a social graph, the location of friends within a social graph, opening and application event (e.g., relating to the messaging client application 104).

The application server 112 hosts a number of applications and subsystems, including a messaging server application 114, an image processing system 116, a social network system 122, and an AR system 124. The messaging server application 114 implements a number of message processing technologies and functions, particularly related to the aggregation and other processing of content (e.g., textual and multimedia content) included in messages received from multiple instances of the messaging client application 104. As will be described in further detail, the text and media content from multiple sources may be aggregated into collections of content (e.g., called stories or galleries). These collections are then made available, by the messaging server application 114, to the messaging client application 104. Other processor and memory intensive processing of data may also be performed server-side by the messaging server application 114, in view of the hardware requirements for such processing.

The application server 112 also includes an image processing system 116 that is dedicated to performing various image processing operations, typically with respect to images or video received within the payload of a message at the messaging server application 114.

The social network system 122 supports various social networking functions services, and makes these functions and services available to the messaging server application 114. To this end, the social network system 122 maintains and accesses an entity graph 304 within the database 120. Examples of functions and services supported by the social network system 122 include the identification of other users of the messaging system 100 with which a particular user has relationships or is “following,” and also the identification of other entities and interests of a particular user.

The application server 112 is communicatively coupled to a database server 118, which facilitates access to a database 120 in which is stored data associated with messages processed by the messaging server application 114.

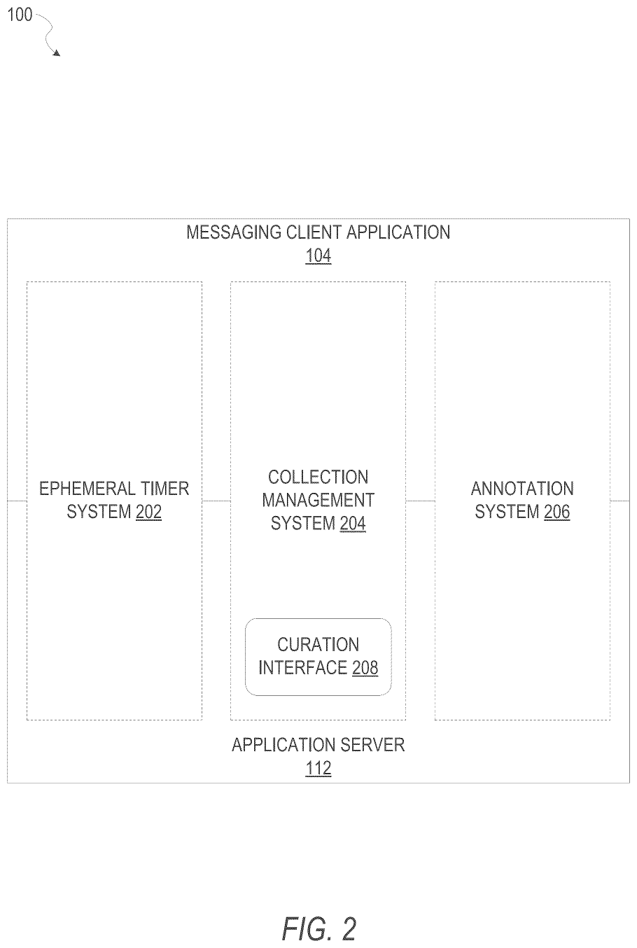

FIG. 2 is block diagram illustrating further details regarding the messaging system 100, according to example embodiments. Specifically, the messaging system 100 is shown to comprise the messaging client application 104 and the application server 112, which in turn embody a number of some subsystems, namely an ephemeral timer system 202, a collection management system 204 and an annotation system 206.

The ephemeral timer system 202 is responsible for enforcing the temporary access to content permitted by the messaging client application 104 and the messaging server application 114. To this end, the ephemeral timer system 202 incorporates a number of timers that, based on duration and display parameters associated with a message, collection of messages (e.g., a SNAPCHAT story), or graphical element, selectively display and enable access to messages and associated content via the messaging client application 104. Further details regarding the operation of the ephemeral timer system 202 are provided below.

The collection management system 204 is responsible for managing collections of media (e.g., collections of text, image video and audio data). In some examples, a collection of content (e.g., messages, including images, video, text and audio) may be organized into an “event gallery” or an “event story.” Such a collection may be made available for a specified time period, such as the duration of an event to which the content relates. For example, content relating to a music concert may be made available as a “story” for the duration of that music concert. The collection management system 204 may also be responsible for publishing an icon that provides notification of the existence of a particular collection to the user interface of the messaging client application 104.

The collection management system 204 furthermore includes a curation interface 208 that allows a collection manager to manage and curate a particular collection of content. For example, the curation interface 208 enables an event organizer to curate a collection of content relating to a specific event (e.g., delete inappropriate content or redundant messages). Additionally, the collection management system 204 employs machine vision (or image recognition technology) and content rules to automatically curate a content collection. In certain embodiments, compensation may be paid to a user for inclusion of user generated content into a collection. In such cases, the curation interface 208 operates to automatically make payments to such users for the use of their content.

The annotation system 206 provides various functions that enable a user to annotate or otherwise modify or edit media content associated with a message. For example, the annotation system 206 provides functions related to the generation and publishing of media overlays for messages processed by the messaging system 100. The annotation system 206 operatively supplies a media overlay (e.g., a SNAPCHAT filter) to the messaging client application 104 based on a geolocation of the client device 102. In another example, the annotation system 206 operatively supplies a media overlay to the messaging client application 104 based on other information, such as, social network information of the user of the client device 102. A media overlay may include audio and visual content and visual effects. Examples of audio and visual content include pictures, texts, logos, animations, and sound effects. An example of a visual effect includes color overlaying. The audio and visual content or the visual effects can be applied to a media content item (e.g., a photo) at the client device 102. For example, the media overlay including text that can be overlaid on top of a photograph generated taken by the client device 102. In another example, the media overlay includes an identification of a location overlay (e.g., Venice beach), a name of a live event, or a name of a merchant overlay (e.g., Beach Coffee House). In another example, the annotation system 206 uses the geolocation of the client device 102 to identify a media overlay that includes the name of a merchant at the geolocation of the client device 102. The media overlay may include other indicia associated with the merchant. The media overlays may be stored in the database 120 and accessed through the database server 118.

In one example embodiment, the annotation system 206 provides a user-based publication platform that enables users to select a geolocation on a map, and upload content associated with the selected geolocation. The user may also specify circumstances under which a particular media overlay should be offered to other users. The annotation system 206 generates a media overlay that includes the uploaded content and associates the uploaded content with the selected geolocation.

In another example embodiment, the annotation system 206 provides a merchant-based publication platform that enables merchants to select a particular media overlay associated with a geolocation via a bidding process. For example, the annotation system 206 associates the media overlay of a highest bidding merchant with a corresponding geolocation for a predefined amount of time

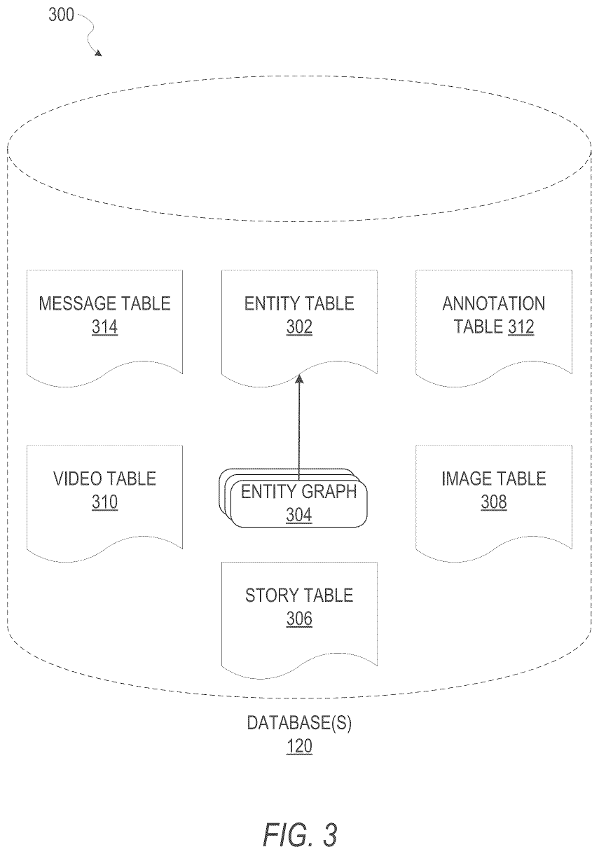

FIG. 3 is a schematic diagram 300 illustrating data 300 which may be stored in the database 120 of the messaging server system 108, according to certain example embodiments. While the content of the database 120 is shown to comprise a number of tables, it will be appreciated that the data could be stored in other types of data structures (e.g., as an object-oriented database).

The database 120 includes message data stored within a message table 314. The entity table 302 stores entity data, including an entity graph 304. Entities for which records are maintained within the entity table 302 may include individuals, corporate entities, organizations, objects, places, events etc. Regardless of type, any entity regarding which the messaging server system 108 stores data may be a recognized entity. Each entity is provided with a unique identifier, as well as an entity type identifier (not shown).

The entity graph 304 furthermore stores information regarding relationships and associations between entities. Such relationships may be social, professional (e.g., work at a common corporation or organization) interested-based or activity-based, merely for example.

The database 120 also stores annotation data, in the example form of filters, in an annotation table 312. Filters for which data is stored within the annotation table 312 are associated with and applied to videos (for which data is stored in a video table 310) and/or images (for which data is stored in an image table 308). Filters, in one example, are overlays that are displayed as overlaid on an image or video during presentation to a recipient user. Filters may be of varies types, including a user-selected filters from a gallery of filters presented to a sending user by the messaging client application 104 when the sending user is composing a message. Other types of filers include geolocation filters (also known as geo-filters) which may be presented to a sending user based on geographic location. For example, geolocation filters specific to a neighborhood or special location may be presented within a user interface by the messaging client application 104, based on geolocation information determined by a GPS unit of the client device 102. Another type of filer is a data filer, which may be selectively presented to a sending user by the messaging client application 104, based on other inputs or information gathered by the client device 102 during the message creation process. Example of data filters include current temperature at a specific location, a current speed at which a sending user is traveling, battery life for a client device 102 or the current time.

Other annotation data that may be stored within the image table 308 is so-called “lens” data. A “lens” may be a real-time special effect and sound that may be added to an image or a video.

As mentioned above, the video table 310 stores video data which, in one embodiment, is associated with messages for which records are maintained within the message table 314. Similarly, the image table 308 stores image data associated with messages for which message data is stored in the entity table 302. The entity table 302 may associate various annotations from the annotation table 312 with various images and videos stored in the image table 308 and the video table 310.

A story table 306 stores data regarding collections of messages and associated image, video or audio data, which are compiled into a collection (e.g., a SNAPCHAT story or a gallery). The creation of a particular collection may be initiated by a particular user (e.g., each user for which a record is maintained in the entity table 302) A user may create a “personal story” in the form of a collection of content that has been created and sent/broadcast by that user. To this end, the user interface of the messaging client application 104 may include an icon that is user selectable to enable a sending user to add specific content to his or her personal story.

A collection may also constitute a “live story,” which is a collection of content from multiple users that is created manually, automatically or using a combination of manual and automatic techniques. For example, a “live story” may constitute a curated stream of user-submitted content from varies locations and events. Users, whose client devices have location services enabled and are at a common location event at a particular time may, for example, be presented with an option, via a user interface of the messaging client application 104, to contribute content to a particular live story. The live story may be identified to the user by the messaging client application 104, based on his or her location. The end result is a “live story” told from a community perspective.

A further type of content collection is known as a “location story”, which enables a user whose client device 102 is located within a specific geographic location (e.g., on a college or university campus) to contribute to a particular collection. In some embodiments, a contribution to a location story may require a second degree of authentication to verify that the end user belongs to a specific organization or other entity (e.g., is a student on the university campus).

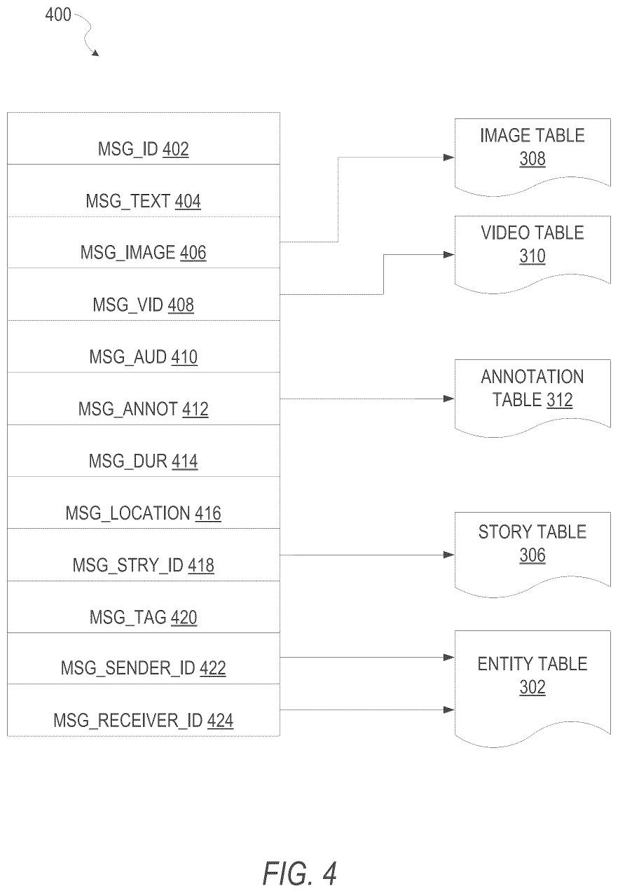

FIG. 4 is a schematic diagram illustrating a structure of a message 400, according to some in some embodiments, generated by a messaging client application 104 for communication to a further messaging client application 104 or the messaging server application 114. The content of a particular message 400 is used to populate the message table 314 stored within the database 120, accessible by the messaging server application 114. Similarly, the content of a message 400 is stored in memory as “in-transit” or “in-flight” data of the client device 102 or the application server 112. The message 400 is shown to include the following components:
A message identifier 402: a unique identifier that identifies the message 400.
A message text payload 404: text, to be generated by a user via a user interface of the client device 102 and that is included in the message 400.
A message image payload 406: image data, captured by a camera component of a client device 102 or retrieved from memory of a client device 102, and that is included in the message 400.
A message video payload 408: video data, captured by a camera component or retrieved from a memory component of the client device 102 and that is included in the message 400.
A message audio payload 410: audio data, captured by a microphone or retrieved from the memory component of the client device 102, and that is included in the message 400.
A message annotations 412: annotation data (e.g., filters, stickers or other enhancements) that represents annotations to be applied to message image payload 406, message video payload 408, or message audio payload 410 of the message 400.
A message duration parameter 414: parameter value indicating, in seconds, the amount of time for which content of the message (e.g., the message image payload 406, message video payload 408, message audio payload 410) is to be presented or made accessible to a user via the messaging client application 104.
A message geolocation parameter 416: geolocation data (e.g., latitudinal and longitudinal coordinates) associated with the content payload of the message. Multiple message geolocation parameter 416 values may be included in the payload, each of these parameter values being associated with respect to content items included in the content (e.g., a specific image into within the message image payload 406, or a specific video in the message video payload 408).
A message story identifier 418: identifier values identifying one or more content collections (e.g., “stories”) with which a particular content item in the message image payload 406 of the message 400 is associated. For example, multiple images within the message image payload 406 may each be associated with multiple content collections using identifier values.
A message tag 420: each message 400 may be tagged with multiple tags, each of which is indicative of the subject matter of content included in the message payload. For example, where a particular image included in the message image payload 406 depicts an animal (e.g., a lion), a tag value may be included within the message tag 420 that is indicative of the relevant animal. Tag values may be generated manually, based on user input, or may be automatically generated using, for example, image recognition.
A message sender identifier 422: an identifier (e.g., a messaging system identifier, email address or device identifier) indicative of a user of the client device 102 on which the message 400 was generated and from which the message 400 was sent
A message receiver identifier 424: an identifier (e.g., a messaging system identifier, email address or device identifier) indicative of a user of the client device 102 to which the message 400 is addressed.

The contents (e.g. values) of the various components of message 400 may be pointers to locations in tables within which content data values are stored. For example, an image value in the message image payload 406 may be a pointer to (or address of) a location within an image table 308. Similarly, values within the message video payload 408 may point to data stored within a video table 310, values stored within the message annotations 412 may point to data stored in an annotation table 312, values stored within the message story identifier 418 may point to data stored in a story table 306, and values stored within the message sender identifier 422 and the message receiver identifier 424 may point to user records stored within an entity table 302.

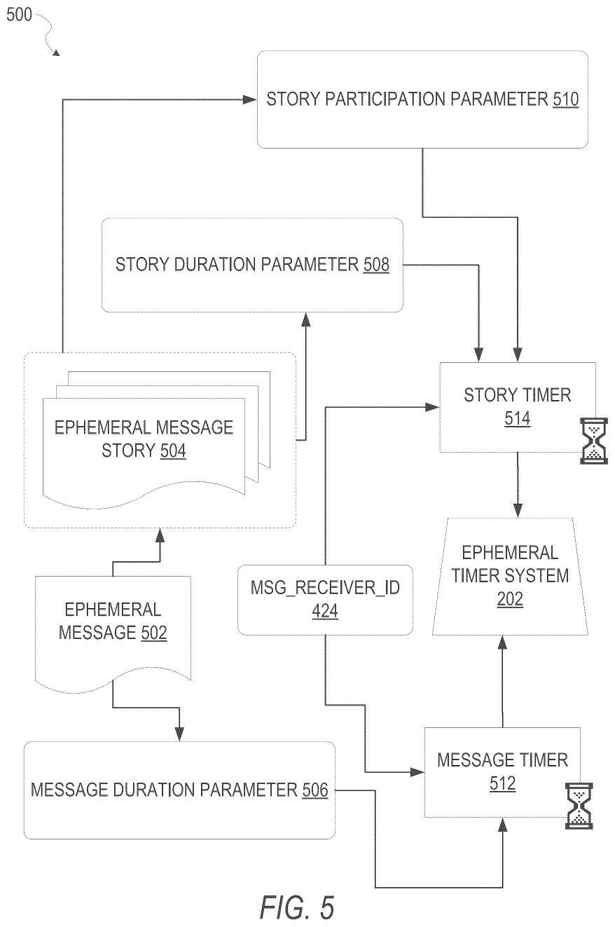

FIG. 5 is a schematic diagram illustrating an access-limiting process 500, in terms of which access to content (e.g., an ephemeral message 502, and associated multimedia payload of data) or a content collection (e.g., an ephemeral message story 504) may be time-limited (e.g., made ephemeral).

An ephemeral message 502 is shown to be associated with a message duration parameter 506, the value of which determines an amount of time that the ephemeral message 502 will be displayed to a receiving user of the ephemeral message 502 by the messaging client application 104. In one embodiment, where the messaging client application 104 is a SNAPCHAT application client, an ephemeral message 502 is viewable by a receiving user for up to a maximum of 10 seconds, depending on the amount of time that the sending user specifies using the message duration parameter 506.

The message duration parameter 506 and the message receiver identifier 424 are shown to be inputs to a message timer 512, which is responsible for determining the amount of time that the ephemeral message 502 is shown to a particular receiving user identified by the message receiver identifier 424. In particular, the ephemeral message 502 will only be shown to the relevant receiving user for a time period determined by the value of the message duration parameter 506. The message timer 512 is shown to provide output to a more generalized ephemeral timer system 202, which is responsible for the overall timing of display of content (e.g., an ephemeral message 502) to a receiving user.

The ephemeral message 502 is shown in FIG. 5 to be included within an ephemeral message story 504 (e.g., a personal SNAPCHAT story, or an event story). The ephemeral message story 504 has an associated story duration parameter 508, a value of which determines a time-duration for which the ephemeral message story 504 is presented and accessible to users of the messaging system 100. The story duration parameter 508, for example, may be the duration of a music concert, where the ephemeral message story 504 is a collection of content pertaining to that concert. Alternatively, a user (either the owning user or a curator user) may specify the value for the story duration parameter 508 when performing the setup and creation of the ephemeral message story 504.

Additionally, each ephemeral message 502 within the ephemeral message story 504 has an associated story participation parameter 510, a value of which determines the duration of time for which the ephemeral message 502 will be accessible within the context of the ephemeral message story 504. Accordingly, a particular ephemeral message story 504 may “expire” and become inaccessible within the context of the ephemeral message story 504, prior to the ephemeral message story 504 itself expiring in terms of the story duration parameter 508. The story duration parameter 508, story participation parameter 510, and message receiver identifier 424 each provide input to a story timer 514, which operationally determines, firstly, whether a particular ephemeral message 502 of the ephemeral message story 504 will be displayed to a particular receiving user and, if so, for how long. Note that the ephemeral message story 504 is also aware of the identity of the particular receiving user as a result of the message receiver identifier 424.

Accordingly, the story timer 514 operationally controls the overall lifespan of an associated ephemeral message story 504, as well as an individual ephemeral message 502 included in the ephemeral message story 504. In one embodiment, each and every ephemeral message 502 within the ephemeral message story 504 remains viewable and accessible for a time-period specified by the story duration parameter 508. In a further embodiment, a certain ephemeral message 502 may expire, within the context of ephemeral message story 504, based on a story participation parameter 510. Note that a message duration parameter 506 may still determine the duration of time for which a particular ephemeral message 502 is displayed to a receiving user, even within the context of the ephemeral message story 504. Accordingly, the message duration parameter 506 determines the duration of time that a particular ephemeral message 502 is displayed to a receiving user, regardless of whether the receiving user is viewing that ephemeral message 502 inside or outside the context of an ephemeral message story 504.

The ephemeral timer system 202 may furthermore operationally remove a particular ephemeral message 502 from the ephemeral message story 504 based on a determination that it has exceeded an associated story participation parameter 510. For example, when a sending user has established a story participation parameter 510 of 24 hours from posting, the ephemeral timer system 202 will remove the relevant ephemeral message 502 from the ephemeral message story 504 after the specified 24 hours. The ephemeral timer system 202 also operates to remove an ephemeral message story 504 either when the story participation parameter 510 for each and every ephemeral message 502 within the ephemeral message story 504 has expired, or when the ephemeral message story 504 itself has expired in terms of the story duration parameter 508.

In certain use cases, a creator of a particular ephemeral message story 504 may specify an indefinite story duration parameter 508. In this case, the expiration of the story participation parameter 510 for the last remaining ephemeral message 502 within the ephemeral message story 504 will determine when the ephemeral message story 504 itself expires. In this case, a new ephemeral message 502, added to the ephemeral message story 504, with a new story participation parameter 510, effectively extends the life of an ephemeral message story 504 to equal the value of the story participation parameter 510.

Responsive to the ephemeral timer system 202 determining that an ephemeral message story 504 has expired (e.g., is no longer accessible), the ephemeral timer system 202 communicates with the messaging system 100 (and, for example, specifically the messaging client application 104 to cause an indicium (e.g., an icon) associated with the relevant ephemeral message story 504 to no longer be displayed within a user interface of the messaging client application 104. Similarly, when the ephemeral timer system 202 determines that the message duration parameter 506 for a particular ephemeral message 502 has expired, the ephemeral timer system 202 causes the messaging client application 104 to no longer display an indicium (e.g., an icon or textual identification) associated with the ephemeral message 502.

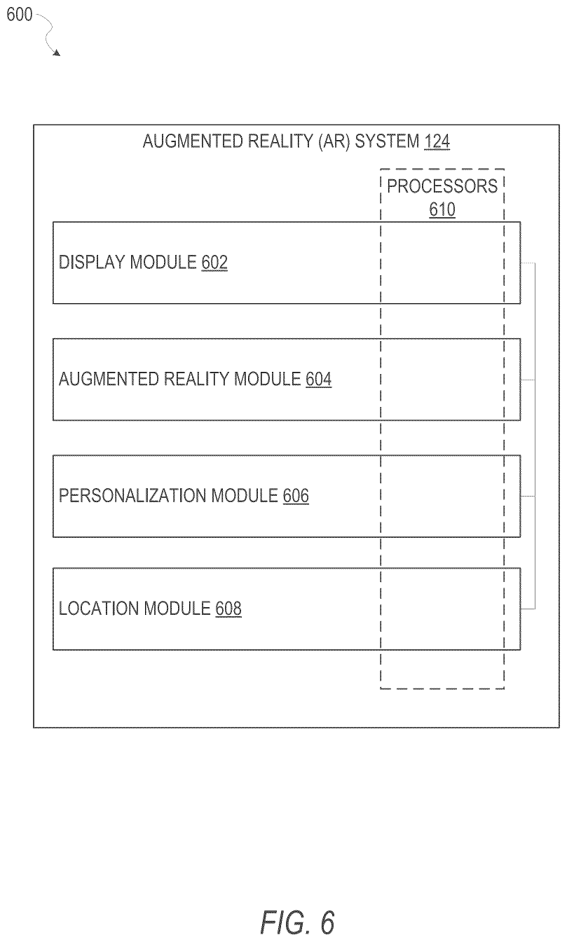

FIG. 6 is a block diagram illustrating components of the AR system 124, that configure the AR system 124 to cause display of a presentation of a space at a client device, receive a selection of a point within the presentation of the space from the client device, and render a graphical element at the point within the space, according to some example embodiments. The AR system 124 is shown as including a display module 602, an augmented reality module 604, a personalization module 606, and a location module 608, all configured to communicate with each other (e.g., via a bus, shared memory, or a switch). Any one or more of these modules may be implemented using one or more processors 610 (e.g., by configuring such one or more processors to perform functions described for that module) and hence may include one or more of the processors 610.

Any one or more of the modules described may be implemented using hardware alone (e.g., one or more of the processors 610 of a machine) or a combination of hardware and software. For example, any module described of the AR system 124 may physically include an arrangement of one or more of the processors 610 (e.g., a subset of or among the one or more processors of the machine) configured to perform the operations described herein for that module. As another example, any module of the AR system 124 may include software, hardware, or both, that configure an arrangement of one or more processors 610 (e.g., among the one or more processors of the machine) to perform the operations described herein for that module. Accordingly, different modules of the AR system 124 may include and configure different arrangements of such processors 610 or a single arrangement of such processors 610 at different points in time. Moreover, any two or more modules of the AR system 124 may be combined into a single module, and the functions described herein for a single module may be subdivided among multiple modules. Furthermore, according to various example embodiments, modules described herein as being implemented within a single machine, database, or device may be distributed across multiple machines, databases, or devices.

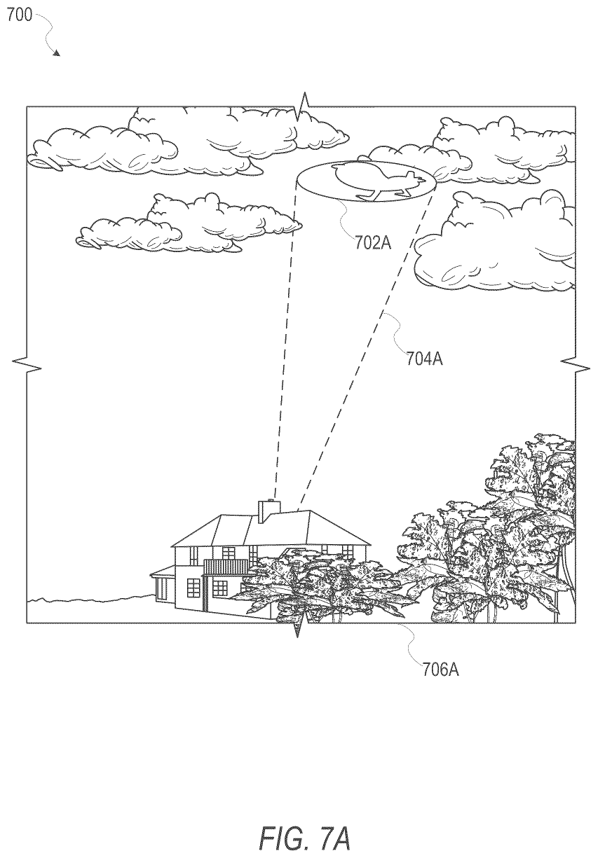

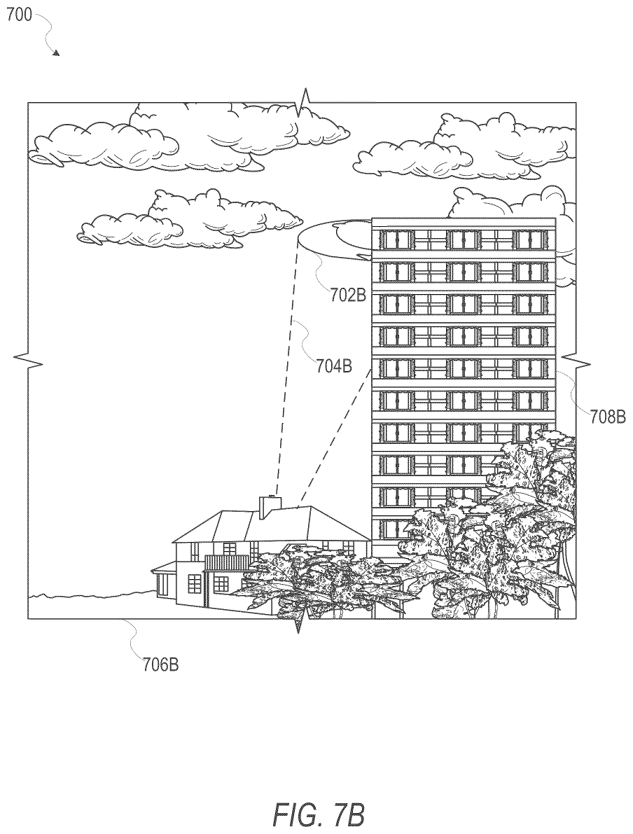

FIG. 7A includes a depictions of an exemplary AR interface 700 to display an AR presentation of media content, according to certain example embodiments. As seen in FIG. 7, the AR interface 700 includes a presentation 706A of a space, a graphical element 702A, and an indication 704A of a location of a client device 102, wherein the client device 102 is a source of the graphical element 702A.

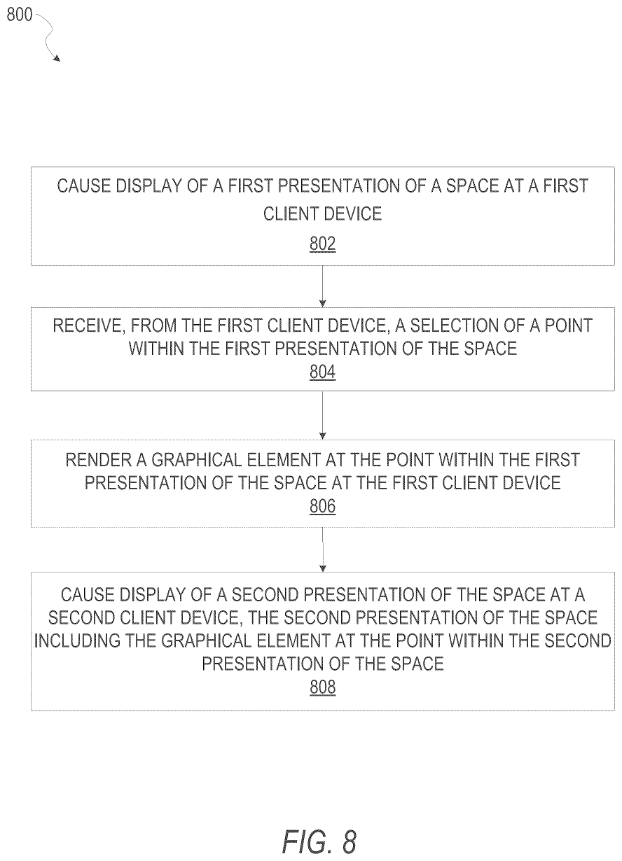

The AR interface 700 depicted in FIG. 7 may be generated based on the methods 800, 900, and 1000 of FIGS. 8, 9, and 10 respectively. As shown in FIG. 7, the AR interface 700 comprises a presentation 706A of a space, that includes a graphical element 702A presented at a point within the presentation 706A, and an indication 704A of the location of the client device (e.g., client device 102) which caused display of the graphical element 702A.

For example, the AR system 124 may receive user inputs from a first client device to render the graphical element 702A at the point within the space depicted by the presentation 706A, wherein the first client device is at a first location. The user inputs may include rotation and translation inputs to adjust and alter an orientation of the graphical element 702A within the presentation of the space 706A. A second client device may cause display of the presentation 706A. From the perspective of the second client device, the graphical element 702A appears to be floating above the location of the first client device. The indication 704A may therefore provide an indication of the location of the first client device.

In some example embodiments, a user of the second client device may provide one or more user inputs interacting with the graphical element 702A, into the AR interface 700. For example, the user inputs may include tactile inputs, such as tapping, flicking, swiping, pinching, or spreading the graphical element 702A in the presentation 706A. In response to receiving such inputs, the AR system 124 may re-render the graphical element 702A at the first client device and the second client device, in real time. Thus, a user of the first client device may be presented with changes and adjustments to the size, position, as well as location of the graphical element 702A at a presentation displayed at the first client device.

In some example embodiments, the graphical element 702A may include coded data, such as a matrix barcode. For example, an image depicted by the graphical element 702A may be embedded with a matrix barcode such as a QR code. In response to displaying the presentation 706A that includes the graphical element 702A which includes the coded data, a client device 102 may cause the AR system 124 to retrieve and cause display of media content associated with the coded data. For example, the coded data may be associated with a media item within a database in communication with the AR system 124. The AR system 124 may receive an indication that a client device 102 has displayed the graphical element 702A that includes coded data. In response, the AR system 124 may retrieve the associated media item and cause display of the associated media item at the client device 102.

In some example embodiments, the graphical element 702A may include an ephemeral element, wherein the ephemeral element has an associated display duration. The AR system 124 may detect an expiration of the display duration, and in response, remove the graphical element 702A from the presentation 706A.

FIG. 7B is a diagram illustrating the AR interface 700 generated by the AR system 124, according to certain example embodiments. As seen in FIG. 7, the AR interface 700 includes a presentation 706B of a space, a graphical element 702B, an indication 704B of a location of a client device 102, wherein the client device 102 is a source of the graphical element 702A, and an obstruction 708B, wherein the obstruction 708B obstructs a perspective of the graphical element 702B.

In some example embodiments, in response to detecting the obstruction 708B within the presentation 706B of the space, the AR system 124 may alter the graphical element 702B such that only a portion of the graphical element 702B is rendered within the presentation 706B. The AR system 124 may employ a number of image recognition and edge detection techniques to detect the obstruction 708B within the presentation 706B. The AR system 124 may then alter the graphical element 702B based on properties of the obstruction 708B. In some example embodiments, the AR system 124 determines a distance between a viewing user (e.g., a user displaying the AR interface 700 at a client device) and the obstruction 708B, and may render the graphical element 702B within the presentation of the space 706B based on the distance and the obstruction 708B.

For example, in some embodiments, the AR system 124 may detect the obstruction 708B through image segmentation techniques. For example, before rendering the graphical element 702B within the presentation of the space 706B, the AR system 124 may segment the presentation of the space 706B into foreground and background portions, or by identifying a sky depicted in the image. The AR system 124 may then determine a relative position of the graphical element 702B, based on the location specified by the user, to determine whether the graphical element 702B is to be rendered in the foreground or in the background. The AR system 124 may thus identify elements within the presentation of the space 706B that are obstructions, such as the obstruction 708B.

FIG. 8 is a flowchart illustrating various operations of the AR system 124 in performing a method 800 for causing display of an augmented reality presentation of a space, according to certain example embodiments. Operations of the method 800 may be performed by the modules described above with respect to FIG. 6. As shown in FIG. 8, the method 800 includes one or more operations 802, 804, 806, and 808.

At operation 802, the display module 602 causes display of a first presentation of a space at a first client device (e.g., client device 102). For example, the client device 102 may include a digital camera, or receive image from a digital camera, and display a presentation at a display of the client device 102 based on image data received from the digital camera. In some example embodiments, the first presentation of the space may be displayed within a graphical user interface displayed at the first client device.

At operation 804, the AR module 604 receives a selection of a point within the first presentation of the space. For example, a user of the first client device may provide a user input specifying the point. The user input may include a tactile input into a touch enabled device. The location module 608 may retrieve location data that includes geolocation coordinates associated with the selected point, as well as an altitude or an estimate of the altitude, of the selected point.

In some example embodiments, in response to receiving the user input selecting the point within the first presentation of the space at the first client device, the AR module 604 may cause display of an augmented reality configuration interface within the graphical user interface at the first client device. The augmented reality configuration interface may for example include a presentation of a set of graphical elements, as well as interfaces to receive user inputs defining properties of the graphical elements. For example, the properties may include a size, color, style, display duration (for the ephemeral timer system 202), as well as a list of users which the graphical element may be visible to in an AR display. The user may provide one or more inputs selecting one or more graphical elements, and defining properties of the graphical element to be displayed. In some example embodiments, the user may simply draw the graphical element directly into the first presentation of the space via a drawing tool (e.g., a digital pen). For example, the user may provide a tactile input tracing a graphical element directly into the first presentation of the space. At operation 806, the AR module 604 renders the selected (or drawn) graphical element at the point within the first presentation of the space at the first client device. The user may additionally provide inputs adjusting an orientation of the graphical element. For example, the user may rotate or translate the graphical element within the presentation of the space.

In some example embodiments, the AR module 604 assigns the location data of the selected point to the graphical element selected by the user, such that the graphical element is “tied” to the location. In this way, as a client device 102 displays the space that includes the point, the AR module 604 determines that the point is within a presentation of the space at the client device 102, and in response may retrieve the graphical element to be displayed within the presentation of the space at the client device 102.

At operation 808, the display module 602 receives a request to display a second presentation of the space from a second client device (e.g., a second client device 102 from among the client devices 102). In response to receiving the request to display the second presentation of the space at the second client device, the display module 602 generates and causes display of the second presentation of the space at the second client device, wherein the second presentation of the space includes the graphical element at the point within the second presentation.

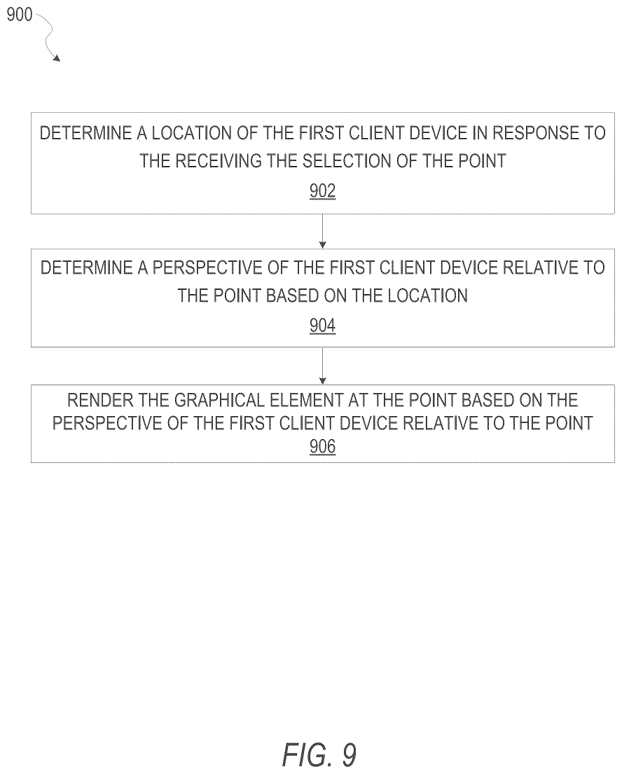

FIG. 9 is a flowchart illustrating various operations of the AR system 124 in performing a method 900 for causing display of an augmented reality presentation of a space, according to certain example embodiments. Operations of the method 900 may be performed by the modules described above with respect to FIG. 6. As shown in FIG. 9, the method 900 includes one or more operations 902, 904, and 906. The method 900 may be performed as part (e.g., a precursor task, a subroutine, or a portion) of the method 800, according to some example embodiments.

Operation 902 may be performed as a precursor task to operation 804 of the method 800, as depicted in FIG. 8. At operation 902, the location module 608 determines a location of the first client device in response to a user of the first client device providing a user input that selects a point within the first presentation of the space. The location of the first client device may include geolocation coordinate as well as an altitude of the first client device. In response to receiving the user input, the display module 602 may cause the personalization module 606 to retrieve location data from the client device 102 (e.g., the first client device), wherein the location data indicates a location and an altitude of the first client device. For example, location module 608 may utilize a Global Positioning System (GPS) to determine a location and altitude of the first client device.

At operation 904, the AR module 604 determines a perspective of the first client device relative to the point selected by the user of the first client device, based on the location data. The perspective of the first client device may be defined as a field of view from the location of the first client device, wherein the field of view is the extent of the space that is observable by the user through the first client device. The perspective may also include an angular extent, wherein the angular extent defines a viewing angle of the first client device with respect to the selected point within the space.

At operation 906, the AR module 604 renders the graphical element at the point within the first presentation of the space at the first client device, based on the perspective of the first client device relative to the selected point. In some example embodiments, the AR module 604 may determine an orientation of the graphical element based on the perspective of the first client device relative to the selected point. In some embodiments, the user may provide inputs adjusting the orientation of the graphical element by rotating or translating the graphical element via various user inputs. Based on the orientation of the graphical element, the AR module 604 may alter a rendering of the graphical element by adjusting properties of the graphical element such as height, width, or color. The AR module 604 may make adjustments to the rendering of the graphical element in real time, as location data is retrieved from the first client device, and the perspective of the first client device is calculated and recalculated.

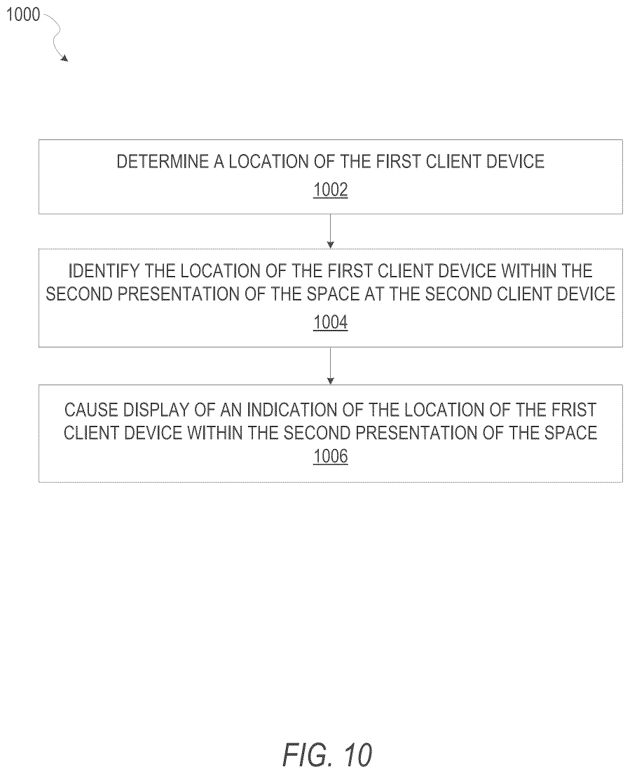

FIG. 10 is a flowchart illustrating various operations of the AR system 124 in performing a method 1000 for causing display of an augmented reality presentation of a space, according to certain example embodiments. Operations of the method 1000 may be performed by the modules described above with respect to FIG. 6. As shown in FIG. 10, the method 1000 includes one or more operations 1002, 1004, and 1006. The method 1000 may be performed as part (e.g., a precursor task, a subroutine, or a portion) of the method 800, according to some example embodiments.

Operation 1002 may be performed in response to operation 804, wherein the AR module 604 receives a selection of a point within the first presentation of the space. In response to receiving the selection of the point, the location module 608 retrieves location data associated with the first client device (e.g., a client device 102).

Operations 1004 and 1006 may be performed as a subroutine of operation 808 of the method 800, as depicted in FIG. 8. At operation 808, the display module 602 receives a request to display the second presentation of the space from a second client device. In response to receiving the request to display the second presentation of the space at the second client device, the location module 608 identifies the location of the first client device within the second presentation of the space, based on the location data from the first client device.

At operation 1006, the AR module 604 renders the graphical element within the second presentation of the space at the second client device, wherein the graphical element includes an indication of the location of the first client device. For example, the indication of the location of the first client device may include a line segment or similar feature leading from the graphical element to the location of the first client device within the second presentation of the space.

### Software Architecture

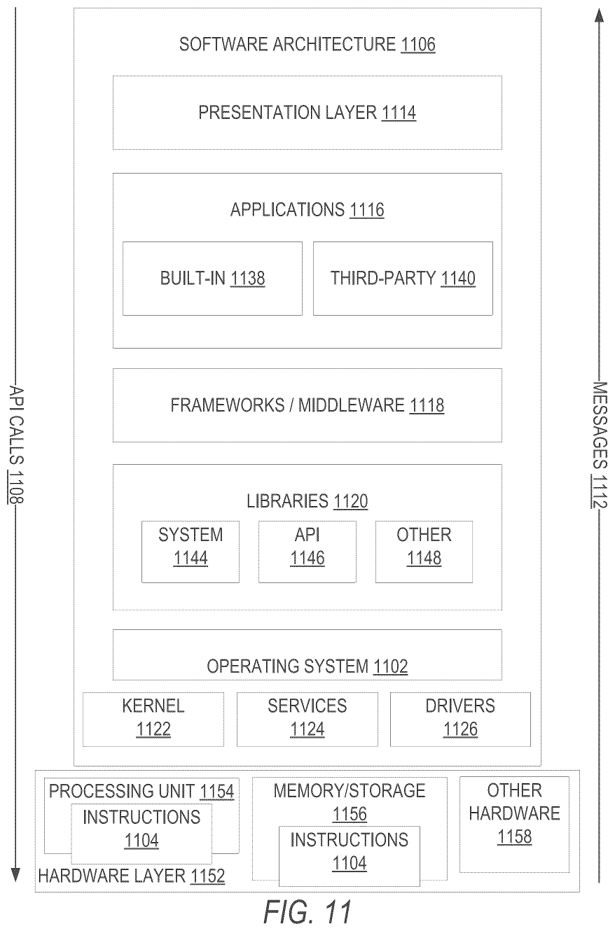

FIG. 11 is a block diagram illustrating an example software architecture 1106, which may be used in conjunction with various hardware architectures herein described. FIG. 11 is a non-limiting example of a software architecture and it will be appreciated that many other architectures may be implemented to facilitate the functionality described herein. The software architecture 1106 may execute on hardware such as machine 700 of FIG. 11 that includes, among other things, processors 1104, memory 1114, and I/O components 1118. A representative hardware layer 1152 is illustrated and can represent, for example, the machine 1100 of FIG. 11. The representative hardware layer 1152 includes a processing unit 1154 having associated executable instructions 1104. Executable instructions 1104 represent the executable instructions of the software architecture 1106, including implementation of the methods, components and so forth described herein. The hardware layer 1152 also includes memory and/or storage modules memory/storage 1156, which also have executable instructions 1104. The hardware layer 1152 may also comprise other hardware 1158.

In the example architecture of FIG. 11, the software architecture 1106 may be conceptualized as a stack of layers where each layer provides particular functionality. For example, the software architecture 1106 may include layers such as an operating system 1102, libraries 1120, applications 1116 and a presentation layer 1114. Operationally, the applications 1116 and/or other components within the layers may invoke application programming interface (API) API calls 1108 through the software stack and receive a response as in response to the API calls 1108. The layers illustrated are representative in nature and not all software architectures have all layers. For example, some mobile or special purpose operating systems may not provide a frameworks/middleware 1118, while others may provide such a layer. Other software architectures may include additional or different layers.

The operating system 1102 may manage hardware resources and provide common services. The operating system 1102 may include, for example, a kernel 1122, services 1124 and drivers 1126. The kernel 1122 may act as an abstraction layer between the hardware and the other software layers. For example, the kernel 1122 may be responsible for memory management, processor management (e.g., scheduling), component management, networking, security settings, and so on. The services 1124 may provide other common services for the other software layers. The drivers 1126 are responsible for controlling or interfacing with the underlying hardware. For instance, the drivers 1126 include display drivers, camera drivers, Bluetooth® drivers, flash memory drivers, serial communication drivers (e.g., Universal Serial Bus (USB) drivers), Wi-Fi® drivers, audio drivers, power management drivers, and so forth depending on the hardware configuration.

The libraries 1120 provide a common infrastructure that is used by the applications 1116 and/or other components and/or layers. The libraries 1120 provide functionality that allows other software components to perform tasks in an easier fashion than to interface directly with the underlying operating system 1102 functionality (e.g., kernel 1122, services 1124 and/or drivers 1126). The libraries 1120 may include system libraries 1144 (e.g., C standard library) that may provide functions such as memory allocation functions, string manipulation functions, mathematical functions, and the like. In addition, the libraries 1120 may include API libraries 1146 such as media libraries (e.g., libraries to support presentation and manipulation of various media format such as MPREG4, H.264, MP3, AAC, AMR, JPG, PNG), graphics libraries (e.g., an OpenGL framework that may be used to render 2D and 3D in a graphic content on a display), database libraries (e.g., SQLite that may provide various relational database functions), web libraries (e.g., WebKit that may provide web browsing functionality), and the like. The libraries 1120 may also include a wide variety of other libraries 1148 to provide many other APIs to the applications 1116 and other software components/modules.

The frameworks/middleware 1118 (also sometimes referred to as middleware) provide a higher-level common infrastructure that may be used by the applications 1116 and/or other software components/modules. For example, the frameworks/middleware 1118 may provide various graphic user interface (GUI) functions, high-level resource management, high-level location services, and so forth. The frameworks/middleware 1118 may provide a broad spectrum of other APIs that may be utilized by the applications 1116 and/or other software components/modules, some of which may be specific to a particular operating system 1102 or platform.

The applications 1116 include built-in applications 1138 and/or third-party applications 1140. Examples of representative built-in applications 1138 may include, but are not limited to, a contacts application, a browser application, a book reader application, a location application, a media application, a messaging application, and/or a game application. Third-party applications 1140 may include an application developed using the ANDROID™ or IOS™ software development kit (SDK) by an entity other than the vendor of the particular platform, and may be mobile software running on a mobile operating system such as IOS™, ANDROID™, WINDOWS® Phone, or other mobile operating systems. The third-party applications 1140 may invoke the API calls 1108 provided by the mobile operating system (such as operating system 1102) to facilitate functionality described herein.

The applications 1116 may use built in operating system functions (e.g., kernel 1122, services 1124 and/or drivers 1126), libraries 1120, and frameworks/middleware 1118 to create user interfaces to interact with users of the system. Alternatively, or additionally, in some systems interactions with a user may occur through a presentation layer, such as presentation layer 1114. In these systems, the application/component “logic” can be separated from the aspects of the application/component that interact with a user.

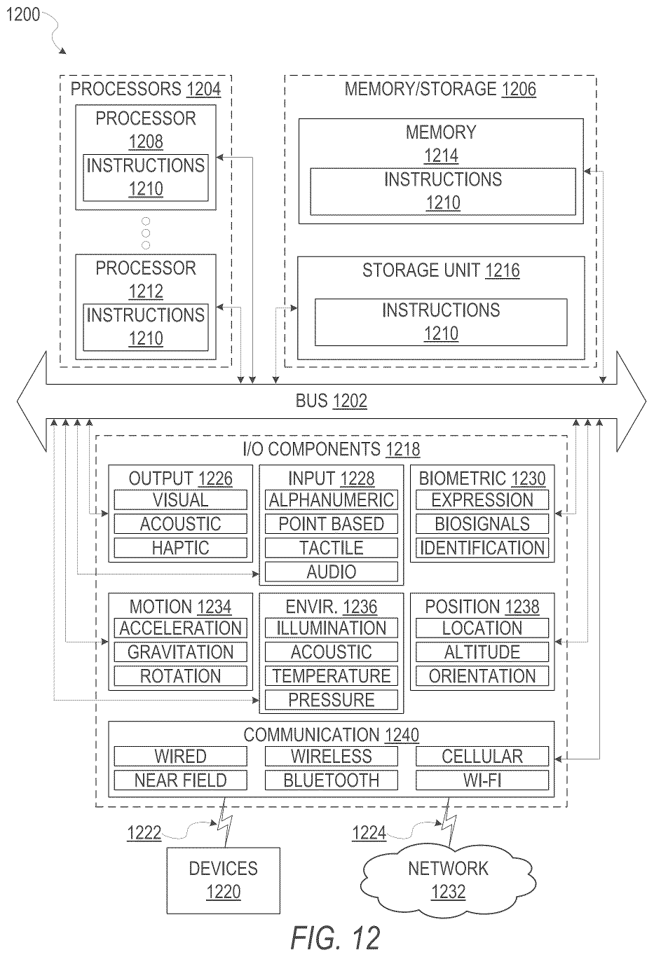

FIG. 12 is a block diagram illustrating components of a machine 1200, according to some example embodiments, able to read instructions from a machine-readable medium (e.g., a machine-readable storage medium) and perform any one or more of the methodologies discussed herein. Specifically, FIG. 12 shows a diagrammatic representation of the machine 1200 in the example form of a computer system, within which instructions 1210 (e.g., software, a program, an application, an applet, an app, or other executable code) for causing the machine 1200 to perform any one or more of the methodologies discussed herein may be executed. As such, the instructions 1210 may be used to implement modules or components described herein. The instructions 1210 transform the general, non-programmed machine 1200 into a particular machine 1200 programmed to carry out the described and illustrated functions in the manner described. In alternative embodiments, the machine 1200 operates as a standalone device or may be coupled (e.g., networked) to other machines. In a networked deployment, the machine 1200 may operate in the capacity of a server machine or a client machine in a server-client network environment, or as a peer machine in a peer-to-peer (or distributed) network environment. The machine 1200 may comprise, but not be limited to, a server computer, a client computer, a personal computer (PC), a tablet computer, a laptop computer, a netbook, a set-top box (STB), a personal digital assistant (PDA), an entertainment media system, a cellular telephone, a smart phone, a mobile device, a wearable device (e.g., a smart watch), a smart home device (e.g., a smart appliance), other smart devices, a web appliance, a network router, a network switch, a network bridge, or any machine capable of executing the instructions 1210, sequentially or otherwise, that specify actions to be taken by machine 1200. Further, while only a single machine 1200 is illustrated, the term “machine” shall also be taken to include a collection of machines that individually or jointly execute the instructions 1210 to perform any one or more of the methodologies discussed herein.

The machine 1200 may include processors 1204, memory memory/storage 1206, and I/O components 1218, which may be configured to communicate with each other such as via a bus 1202. The memory/storage 1206 may include a memory 1214, such as a main memory, or other memory storage, and a storage unit 1216, both accessible to the processors 1204 such as via the bus 1202. The storage unit 1216 and memory 1214 store the instructions 1210 embodying any one or more of the methodologies or functions described herein. The instructions 1210 may also reside, completely or partially, within the memory 1214, within the storage unit 1216, within at least one of the processors 1204 (e.g., within the processor's cache memory), or any suitable combination thereof, during execution thereof by the machine 1200. Accordingly, the memory 1214, the storage unit 1216, and the memory of processors 1204 are examples of machine-readable media.

The I/O components 1218 may include a wide variety of components to receive input, provide output, produce output, transmit information, exchange information, capture measurements, and so on. The specific I/O components 1218 that are included in a particular machine 1200 will depend on the type of machine. For example, portable machines such as mobile phones will likely include a touch input device or other such input mechanisms, while a headless server machine will likely not include such a touch input device. It will be appreciated that the I/O components 1218 may include many other components that are not shown in FIG. 12. The I/O components 1218 are grouped according to functionality merely for simplifying the following discussion and the grouping is in no way limiting. In various example embodiments, the I/O components 1218 may include output components 1226 and input components 1228. The output components 1226 may include visual components (e.g., a display such as a plasma display panel (PDP), a light emitting diode (LED) display, a liquid crystal display (LCD), a projector, or a cathode ray tube (CRT)), acoustic components (e.g., speakers), haptic components (e.g., a vibratory motor, resistance mechanisms), other signal generators, and so forth. The input components 1228 may include alphanumeric input components (e.g., a keyboard, a touch screen configured to receive alphanumeric input, a photo-optical keyboard, or other alphanumeric input components), point based input components (e.g., a mouse, a touchpad, a trackball, a joystick, a motion sensor, or other pointing instrument), tactile input components (e.g., a physical button, a touch screen that provides location and/or force of touches or touch gestures, or other tactile input components), audio input components (e.g., a microphone), and the like.

In further example embodiments, the I/O components 1218 may include biometric components 1230, motion components 1234, environmental environment components 1236, or position components 1238 among a wide array of other components. For example, the biometric components 1230 may include components to detect expressions (e.g., hand expressions, facial expressions, vocal expressions, body gestures, or eye tracking), measure biosignals (e.g., blood pressure, heart rate, body temperature, perspiration, or brain waves), identify a person (e.g., voice identification, retinal identification, facial identification, fingerprint identification, or electroencephalogram based identification), and the like. The motion components 1234 may include acceleration sensor components (e.g., accelerometer), gravitation sensor components, rotation sensor components (e.g., gyroscope), and so forth. The environment components 1236 may include, for example, illumination sensor components (e.g., photometer), temperature sensor components (e.g., one or more thermometer that detect ambient temperature), humidity sensor components, pressure sensor components (e.g., barometer), acoustic sensor components (e.g., one or more microphones that detect background noise), proximity sensor components (e.g., infrared sensors that detect nearby objects), gas sensors (e.g., gas detection sensors to detection concentrations of hazardous gases for safety or to measure pollutants in the atmosphere), or other components that may provide indications, measurements, or signals corresponding to a surrounding physical environment. The position components 1238 may include location sensor components (e.g., a Global Position system (GPS) receiver component), altitude sensor components (e.g., altimeters or barometers that detect air pressure from which altitude may be derived), orientation sensor components (e.g., magnetometers), and the like.

Communication may be implemented using a wide variety of technologies. The I/O components 1218 may include communication components 1240 operable to couple the machine 1200 to a network 1232 or devices 1220 via coupling 1222 and coupling 1224 respectively. For example, the communication components 1240 may include a network interface component or other suitable device to interface with the network 1232. In further examples, communication components 1240 may include wired communication components, wireless communication components, cellular communication components, Near Field Communication (NFC) components, Bluetooth® components (e.g., Bluetooth® Low Energy), Wi-Fi® components, and other communication components to provide communication via other modalities. The devices 1220 may be another machine or any of a wide variety of peripheral devices (e.g., a peripheral device coupled via a Universal Serial Bus (USB)).

Moreover, the communication components 1240 may detect identifiers or include components operable to detect identifiers. For example, the communication components 1240 may include Radio Frequency Identification (RFID) tag reader components, NFC smart tag detection components, optical reader components (e.g., an optical sensor to detect one-dimensional bar codes such as Universal Product Code (UPC) bar code, multi-dimensional bar codes such as Quick Response (QR) code, Aztec code, Data Matrix, Dataglyph, MaxiCode, PDF417, Ultra Code, UCC RSS-2D bar code, and other optical codes), or acoustic detection components (e.g., microphones to identify tagged audio signals). In addition, a variety of information may be derived via the communication components 1240, such as, location via Internet Protocol (IP) geo-location, location via Wi-Fi® signal triangulation, location via detecting a NFC beacon signal that may indicate a particular location, and so forth.

### Glossary

“CARRIER SIGNAL” in this context refers to any intangible medium that is capable of storing, encoding, or carrying instructions for execution by the machine, and includes digital or analog communications signals or other intangible medium to facilitate communication of such instructions. Instructions may be transmitted or received over the network using a transmission medium via a network interface device and using any one of a number of well-known transfer protocols.

“CLIENT DEVICE” in this context refers to any machine that interfaces to a communications network to obtain resources from one or more server systems or other client devices. A client device may be, but is not limited to, a mobile phone, desktop computer, laptop, portable digital assistants (PDAs), smart phones, tablets, ultra books, netbooks, laptops, multi-processor systems, microprocessor-based or programmable consumer electronics, game consoles, set-top boxes, or any other communication device that a user may use to access a network.

“COMMUNICATIONS NETWORK” in this context refers to one or more portions of a network that may be an ad hoc network, an intranet, an extranet, a virtual private network (VPN), a local area network (LAN), a wireless LAN (WLAN), a wide area network (WAN), a wireless WAN (WWAN), a metropolitan area network (MAN), the Internet, a portion of the Internet, a portion of the Public Switched Telephone Network (PSTN), a plain old telephone service (POTS) network, a cellular telephone network, a wireless network, a Wi-Fi® network, another type of network, or a combination of two or more such networks. For example, a network or a portion of a network may include a wireless or cellular network and the coupling may be a Code Division Multiple Access (CDMA) connection, a Global System for Mobile communications (GSM) connection, or other type of cellular or wireless coupling. In this example, the coupling may implement any of a variety of types of data transfer technology, such as Single Carrier Radio Transmission Technology (1×RTT), Evolution-Data Optimized (EVDO) technology, General Packet Radio Service (GPRS) technology, Enhanced Data rates for GSM Evolution (EDGE) technology, third Generation Partnership Project (3GPP) including 3G, fourth generation wireless (4G) networks, Universal Mobile Telecommunications System (UMTS), High Speed Packet Access (HSPA), Worldwide Interoperability for Microwave Access (WiMAX), Long Term Evolution (LTE) standard, others defined by various standard setting organizations, other long range protocols, or other data transfer technology.

“EMPHEMERAL MESSAGE” in this context refers to a message that is accessible for a time-limited duration. An ephemeral message may be a text, an image, a video and the like. The access time for the ephemeral message may be set by the message sender. Alternatively, the access time may be a default setting or a setting specified by the recipient. Regardless of the setting technique, the message is transitory.

“MACHINE-READABLE MEDIUM” in this context refers to a component, device or other tangible media able to store instructions and data temporarily or permanently and may include, but is not be limited to, random-access memory (RAM), read-only memory (ROM), buffer memory, flash memory, optical media, magnetic media, cache memory, other types of storage (e.g., Erasable Programmable Read-Only Memory (EEPROM)) and/or any suitable combination thereof. The term “machine-readable medium” should be taken to include a single medium or multiple media (e.g., a centralized or distributed database, or associated caches and servers) able to store instructions. The term “machine-readable medium” shall also be taken to include any medium, or combination of multiple media, that is capable of storing instructions (e.g., code) for execution by a machine, such that the instructions, when executed by one or more processors of the machine, cause the machine to perform any one or more of the methodologies described herein. Accordingly, a “machine-readable medium” refers to a single storage apparatus or device, as well as “cloud-based” storage systems or storage networks that include multiple storage apparatus or devices. The term “machine-readable medium” excludes signals per se.

“COMPONENT” in this context refers to a device, physical entity or logic having boundaries defined by function or subroutine calls, branch points, application program interfaces (APIs), or other technologies that provide for the partitioning or modularization of particular processing or control functions. Components may be combined via their interfaces with other components to carry out a machine process. A component may be a packaged functional hardware unit designed for use with other components and a part of a program that usually performs a particular function of related functions. Components may constitute either software components (e.g., code embodied on a machine-readable medium) or hardware components. A “hardware component” is a tangible unit capable of performing certain operations and may be configured or arranged in a certain physical manner. In various example embodiments, one or more computer systems (e.g., a standalone computer system, a client computer system, or a server computer system) or one or more hardware components of a computer system (e.g., a processor or a group of processors) may be configured by software (e.g., an application or application portion) as a hardware component that operates to perform certain operations as described herein. A hardware component may also be implemented mechanically, electronically, or any suitable combination thereof. For example, a hardware component may include dedicated circuitry or logic that is permanently configured to perform certain operations. A hardware component may be a special-purpose processor, such as a Field-Programmable Gate Array (FPGA) or an Application Specific Integrated Circuit (ASIC). A hardware component may also include programmable logic or circuitry that is temporarily configured by software to perform certain operations. For example, a hardware component may include software executed by a general-purpose processor or other programmable processor. Once configured by such software, hardware components become specific machines (or specific components of a machine) uniquely tailored to perform the configured functions and are no longer general-purpose processors. It will be appreciated that the decision to implement a hardware component mechanically, in dedicated and permanently configured circuitry, or in temporarily configured circuitry (e.g., configured by software) may be driven by cost and time considerations. Accordingly, the phrase “hardware component” (or “hardware-implemented component”) should be understood to encompass a tangible entity, be that an entity that is physically constructed, permanently configured (e.g., hardwired), or temporarily configured (e.g., programmed) to operate in a certain manner or to perform certain operations described herein. Considering embodiments in which hardware components are temporarily configured (e.g., programmed), each of the hardware components need not be configured or instantiated at any one instance in time. For example, where a hardware component comprises a general-purpose processor configured by software to become a special-purpose processor, the general-purpose processor may be configured as respectively different special-purpose processors (e.g., comprising different hardware components) at different times. Software accordingly configures a particular processor or processors, for example, to constitute a particular hardware component at one instance of time and to constitute a different hardware component at a different instance of time. Hardware components can provide information to, and receive information from, other hardware components. Accordingly, the described hardware components may be regarded as being communicatively coupled. Where multiple hardware components exist contemporaneously, communications may be achieved through signal transmission (e.g., over appropriate circuits and buses) between or among two or more of the hardware components. In embodiments in which multiple hardware components are configured or instantiated at different times, communications between such hardware components may be achieved, for example, through the storage and retrieval of information in memory structures to which the multiple hardware components have access. For example, one hardware component may perform an operation and store the output of that operation in a memory device to which it is communicatively coupled. A further hardware component may then, at a later time, access the memory device to retrieve and process the stored output. Hardware components may also initiate communications with input or output devices, and can operate on a resource (e.g., a collection of information). The various operations of example methods described herein may be performed, at least partially, by one or more processors that are temporarily configured (e.g., by software) or permanently configured to perform the relevant operations. Whether temporarily or permanently configured, such processors may constitute processor-implemented components that operate to perform one or more operations or functions described herein. As used herein, “processor-implemented component” refers to a hardware component implemented using one or more processors. Similarly, the methods described herein may be at least partially processor-implemented, with a particular processor or processors being an example of hardware. For example, at least some of the operations of a method may be performed by one or more processors or processor-implemented components. Moreover, the one or more processors may also operate to support performance of the relevant operations in a “cloud computing” environment or as a “software as a service” (SaaS). For example, at least some of the operations may be performed by a group of computers (as examples of machines including processors), with these operations being accessible via a network (e.g., the Internet) and via one or more appropriate interfaces (e.g., an Application Program Interface (API)). The performance of certain of the operations may be distributed among the processors, not only residing within a single machine, but deployed across a number of machines. In some example embodiments, the processors or processor-implemented components may be located in a single geographic location (e.g., within a home environment, an office environment, or a server farm). In other example embodiments, the processors or processor-implemented components may be distributed across a number of geographic locations.

“PROCESSOR” in this context refers to any circuit or virtual circuit (a physical circuit emulated by logic executing on an actual processor) that manipulates data values according to control signals (e.g., “commands”, “op codes”, “machine code”, etc.) and which produces corresponding output signals that are applied to operate a machine. A processor may, for example, be a Central Processing Unit (CPU), a Reduced Instruction Set Computing (RISC) processor, a Complex Instruction Set Computing (CISC) processor, a Graphics Processing Unit (GPU), a Digital Signal Processor (DSP), an Application Specific Integrated Circuit (ASIC), a Radio-Frequency Integrated Circuit (RFIC) or any combination thereof. A processor may further be a multi-core processor having two or more independent processors (sometimes referred to as “cores”) that may execute instructions contemporaneously.

“TIMESTAMP” in this context refers to a sequence of characters or encoded information identifying when a certain event occurred, for example giving date and time of day, sometimes accurate to a small fraction of a second.

“LIFT” in this context is a measure of the performance of a targeted model at predicting or classifying cases as having an enhanced response (with respect to a population as a whole), measured against a random choice targeting model.

What is claimed is:

1. A system comprising:
a memory; and
at least one hardware processor coupled to the memory and comprising instructions that causes the system to perform operations comprising:
causing display of a presentation of Augmented-Realty (AR) content at a first client device;
detecting an obstruction within the presentation;
identifying properties of the obstruction;
determining a distance between the first client device and the obstruction;
rendering a graphical element within the presentation based on the properties of the obstruction and the determined distance; and
causing display of the rendered graphical element within the presentation at the first client device.

2. The system of claim 1, wherein the AR content comprises ephemeral content that
comprises a display duration, and the causing display of the presentation of the AR
content is based on the display duration.

3. The system of claim 1, wherein detecting the obstruction comprises employing image recognition and edge detection to detect the obstruction.

4. The system of claim 1, wherein detecting the obstruction within the presentation
comprises:
performing image segmentation on the presentation to identify a
foreground portion and
a background portion;
identifying elements within the foreground portion; and
determining the obstruction based on the identified elements.

5. The system of claim 1, wherein rendering the graphical element comprises:
detecting edges of the obstruction;
altering the graphical element based on properties of the detected edges; and
rendering the altered graphical element within the presentation.

6. The system of claim 1, wherein rendering a graphical element within
the presentation
based on the properties of the obstruction and the determined distance comprises:
detecting the obstruction within the presentation;
determining that the obstruction obstructs a perspective of the graphical element;
identifying visible portions of the graphical element based on the obstruction; and
altering the graphical element to render a portion of the graphical element within the
presentation based on the obstruction.

7. The system of claim 1, wherein the causing display of the presentation of the AR content at the first client device further comprises:
accessing user profile data associated with the client device; and
generating the presentation of the AR content based on the user profile data.

8. The system of claim 1, wherein identifying properties of the obstruction comprises
determining a size and shape of the obstruction relative to the graphical element.

9. The system of claim 1, wherein the graphical element further comprises coded data.

10. The system of claim 9, further comprising:
receiving an indication that the first client device has displayed the graphical element;
retrieving media content associated with the coded data; and
causing display of the media content at the first client device.

11. The system of claim 1, further comprising:
retrieving updated location data from the first client device;
recalculating a perspective of the first client device based on the updated location data; and
adjusting the rendering of the graphical element in real-time based on the recalculated perspective.

12. A method comprising:
causing display of a presentation of Augmented-Realty (AR) content at a first client device;
detecting an obstruction within the presentation;
identifying properties of the obstruction;
determining a distance between the first client device and the obstruction;
rendering a graphical element within the presentation based on the properties of the obstruction and the determined distance; and
causing display of the rendered graphical element within the presentation at the first client device.

13. The method of claim 12, wherein the AR content comprises ephemeral content that
comprises a display duration, and the causing display of the presentation of the AR
content is based on the display duration.

14. The method of claim 12, wherein detecting the obstruction comprises employing image recognition and edge detection to detect the obstruction.

15. The method of claim 12, wherein detecting the obstruction within the presentation
comprises:
performing image segmentation on the presentation to identify a foreground portion and
a background portion;
identifying elements within the foreground portion; and
determining the obstruction based on the identified elements.

16. The method of claim 12, wherein rendering the graphical element comprises:
detecting edges of the obstruction;
altering the graphical element based on properties of the detected edges; and
rendering the altered graphical element within the presentation.

17. The method of claim 12, wherein rendering a graphical element within the presentation
based on the properties of the obstruction and the determined distance comprises:
detecting the obstruction within the presentation;
determining that the obstruction obstructs a perspective of the graphical element;
identifying visible portions of the graphical element based on the obstruction; and
altering the graphical element to render a portion of the graphical element within the
presentation based on the obstruction.

18. The method of claim 12, wherein the causing display of the presentation of the AR content at the first client device further comprises:
accessing user profile data associated with the client device; and
generating the presentation of the AR content based on the user profile data.

19. The method of claim 12, wherein identifying properties of the obstruction comprises
determining a size and shape of the obstruction relative to the graphical element.

20. A non-transitory machine-readable storage medium comprising instructions that, when executed by one or more processors of a machine, cause the machine to perform operations comprising:
causing display of a presentation of Augmented-Realty (AR) content at a first client device;
detecting an obstruction within the presentation;
identifying properties of the obstruction;
determining a distance between the first client device and the obstruction;
rendering a graphical element within the presentation based on the properties of the obstruction and the determined distance; and
causing display of the rendered graphical element within the presentation at the first client device.
